(19) United States
(12) Patent Application Publication
(10) Pub. No.: US 2008/0024454 A1
(43) Pub. Date: Jan. 31, 2008

(54) THREE-DIMENSIONAL TOUCH PAD INPUT DEVICE

(76) Inventor: Paul Everest, Apex, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/461,130

(22) Filed: Jul. 31, 2006

(51) Int. Cl. G06F 3/041

(52) U.S. Cl. 345/173

(57) ABSTRACT

Disclosed is a system, method and computer application for electronic equipment 10 having a user input device that outputs information indicative of a location and an applied pressure of an object touching the user input device. Based on a change in the location and/or applied pressure of the object touching the user input device 20, information is processed move a cursor or other object displayed on a screen. Exemplary movements include zooming in on a portion of the display or zooming out on a portion of the display based upon detected asserted pressure on the user input device. In another embodiment, an object displayed on the display may be manipulated in a predetermined manner based on the signal received from the touchpad, which allows the display to be utilized in three-dimensional manner.

### TECHNICAL FIELD OF THE INVENTION

The present invention relates to a three-dimensional touch pad input device for use in electronic equipment.

### DESCRIPTION OF THE RELATED ART

Electronic equipment, such as, for example, communication devices, mobile phones, personal digital assistants, etc. are typically equipped to communicate with cellular telephone communication networks. Such electronic equipment is increasingly being equipped with adapters to support advanced communications in a variety of mediums. Such advanced communication mediums may include, for example, Ethernet, Bluetooth, 802.11, wireless local area networks (WLANs), WiFi, WiMax and the like.

There exist a number of user input devices that function as position detectors for use in electronic equipment. Such devices include, for example, a computer mouse, a track ball, a touchpad, etc. The computer mouse is widely popular as a position indicating device. A computer mouse has mechanical pans and requires a surface upon which to roll its position sensor. The computer mouse translates movement of the position sensor across a surface as input to a computer. The growing popularity of laptop or notebook computers has created a significant problem for mouse type technologies which require a rolling surface. Laptop computers are inherently portable and designed for use in small confined areas such as, for example, airplanes, where there is insufficient room for a rolling surface. Adding to the problem is that a mouse usually needs to be moved over long distances for reasonable resolution. Finally, a mouse requires the user to lift a hand from the keyboard to make the cursor movement, thereby disrupting the prime purpose, which is usually typing on the computer.

As a result of the proliferation of laptop computers, a trackball was developed. A track ball is similar to a mouse, but does not require a rolling surface. A track ball is generally large in size and does not fit well in a volume-sensitive application such as a laptop computers or other small and/or portable electronic equipment.

A computer touchpad was subsequently developed. A conventional touchpad is a pointing device used for inputting coordinate data to computers and computer-controlled devices. A touchpad is typically a bounded plane capable of detecting localized pressure on its surface. A touchpad may be integrated within a computer or be a separate portable unit connected to a computer like a mouse. When a user touches the touchpad with a finger, stylus, or the like, the circuitry associated with the touchpad determines and reports to the attached computer the coordinates or the position of the location touched. Thus, a touchpad may be used like a mouse as a position indicator for computer cursor control.

Capacitive touchpads react to a capacitive coupling between an object placed near or on the surface of the touchpad and capacitors formed within the touchpad. For instance, U.S. Pat. No. 5,374,787 issued to Miller et al. and assigned to Synaptics, Inc., discloses a capacitive touchpad having two thin layers of electrically conductive lines or traces. A first set of traces runs in a first direction and is insulated by a dielectric insulator from a second set of traces running in a second direction generally perpendicular to the first direction. The two sets of traces are arranged in a crosswise grid pattern. The grid formed by the traces creates an array of capacitors that can store an electrical charge.

When a conductive object such as a finger or a metal stylus approaches or touches the touchpad, the capacitance of the capacitors are altered due to capacitive coupling between the object and the capacitors. The degree of alteration depends on the position of the object with respect to the traces. As a result, the location of the object in relation to the touchpad can be determined and monitored as the object moves across the touchpad.

One drawback with computer touchpads is the difficulty in measuring the amount of applied pressure. Another drawback is the difficulty in translating the amount of applied pressure to allowing zooming in and/or out of a display based on the amount of applied pressure. Still another drawback is the difficulty in translating movement in the x-y axis and pressure to render or otherwise manipulate an object based upon the information detected from the touchpad.

### SUMMARY

In view of the aforementioned shortcomings associated with user input devices, there is a strong need in the art for a three-dimensional touchpad that allows a user to zoom in and/or zoom out

One aspect of the present invention is directed to a mobile telephone comprising: a processor; a user input device for providing a signal to the processor, wherein the signal is indicative of a location and an applied pressure of an object touching the user input device; a display coupled to the processor, wherein the display outputs an output signal corresponding to the signal; and wherein, the processor causes the display to zoom in and/or zoom out based upon a change in the applied pressure.

According to another aspect, the user input device is a touchpad.

According to another aspect, the touchpad is integrated in the mobile telephone.

According to another aspect, the user input device is a touch screen.

According to another aspect, the signal includes a first component related to the location and a second component related to the applied pressure.

According to another aspect, the output signal is in the form of a cursor.

According to another aspect, the display is a liquid crystal display.

According to another aspect, when the processor calculates increasing applied pressure, the display zooms in an area associated with the location.

According to another aspect, when the processor calculates decreasing applied pressure, the display zooms out of an area associated with the location.

Another aspect of the present invention is directed to a mobile telephone comprising: a processor; a touchpad for providing a signal to the processor, wherein the signal is indicative of a location and an applied pressure of an object touching the touchpad; a display coupled to the processor, wherein the display outputs an output signal corresponding to the signal; and wherein, the processor causes the display to zoom in and/or zoom out based upon a change in the applied pressure.

According to another aspect, the touchpad is integrated in the mobile telephone.

According to another aspect, the signal includes a first component related to the location and a second component related to the applied pressure.

According to another aspect, the display is a liquid crystal display.

According to another aspect, the processor calculates increasing applied pressure, the display zooms in an area associated with the location.

According to another aspect, when the processor calculates decreasing applied pressure, the display zooms out of an area associated with the location.

Another aspect of the present invention relates to a method for providing location information and applied pressure information to a processor, the method comprising: providing a touchpad for providing a signal, wherein the signal is indicative of a location and an applied pressure of an object touching the touchpad; receiving a signal from the object touching the touchpad; outputting a signal indicative of the location and the applied pressure; processing the signal in order to determine the location and the applied pressure; and outputting an output signal on a display corresponding to the signal

According to another aspect, the processor determines whether the applied pressure is increasing and/or decreasing.

According to another aspect, the display zooms in on the location if applied pressure is increasing.

According to another aspect, the display zooms out on the location if applied pressure is decreasing.

According to another aspect, providing a tactile feedback based upon the determination of whether the applied pressure is increasing and/or decreasing.

Another aspect of the invention relates to a computer program stored on a machine readable medium in a mobile telephone, the program being suitable for receiving location information and applied pressure information from a touchpad, wherein when the touchpad determines an increase and/or a decrease in applied pressure, a display associated with the mobile telephone zooms in and/or zooms out based upon the amount of applied pressure detected.

Another aspect of the invention relates to a method for manipulating an object on a display, the method comprising: displaying an object on a display; selecting the object with a touchpad, wherein the touchpad provides a signal indicative of a location and an applied pressure of an object touching the touchpad; manipulating the displayed with the user input device; outputting a signal indicative of the location and the applied pressure from the step of manipulation; processing the signal in order to determine the location and the applied pressure; and outputting an output signal on a display corresponding to the signal.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising ” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1A and 1B are exemplary schematic diagrams illustrating electronic equipment in accordance with aspects of the present invention.

FIG. 3 is an exemplary illustration of a user input device in accordance with aspects of the present invention.

FIG. 4 is an exemplary schematic diagram of an electronic equipment in accordance with aspects of the present invention.

FIG. 5 is an exemplary method in accordance with aspects of the present invention.

FIGS. 6A-6C are exemplary displays in accordance with aspects of the present invention.

FIG. 7 is an exemplary method in accordance with aspects of the present invention.

### DETAILED DESCRIPTION OF EMBODIMENTS

The present invention is directed to electronic equipment 10, sometimes referred to herein as a communication device, mobile telephone, and portable telephone having a user input device that outputs information indicative of a location and an applied pressure of an object touching the user input device. Based on a change in the applied pressure, information is processed to zoom in a portion of the display or zoom out on a portion of the display. In another embodiment, an object displayed on the display may be manipulated in a predetermined manner based on the signal received from the touchpad, which allows the display to be utilized in three-dimensional manner.

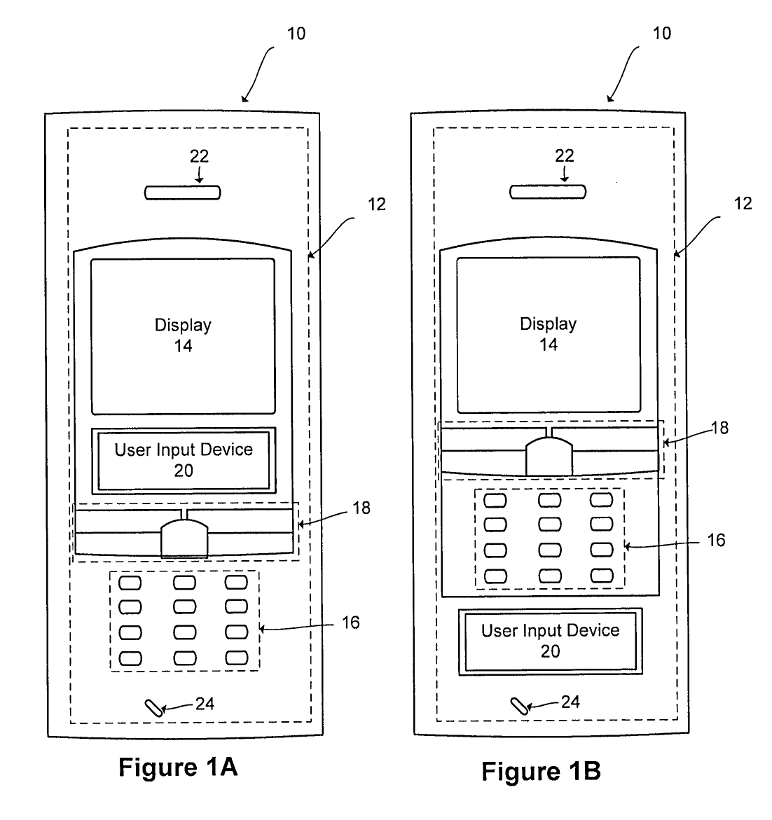

Referring to FIGS. 1A and 1B, electronic equipment 10 is shown in accordance with the present invention. The invention is described primarily in the context of a mobile telephone. However, it will be appreciated that the invention is not intended to relate solely to a mobile telephone and can relate to any type of electronic equipment. Other types of electronic equipment that may benefit from aspects of the present invention include personal computers, laptop computers, playback devices, personal digital assistants, etc.

The mobile telephone 10 is shown as having a “brick” or “block” design type housing, but it will be appreciated that other type housings, such as clamshell housing or a slide-type housing, may be utilized without departing from the scope of the invention.

As illustrated in FIG. 1, the mobile telephone 10 may include a user interface 12 (identified by dotted lines) that enables the user easily and efficiently to perform one or more communication tasks (e.g., identify a contact, select a contact, make a telephone call, receive a telephone call, move a cursor on the display, navigate the display, etc). The user interface 12 of the electronic equipment 10 generally includes one or more of the following components: a display 14, an alphanumeric keypad 16, function keys 18, a user input device 20, a speaker 22 and a microphone 24.

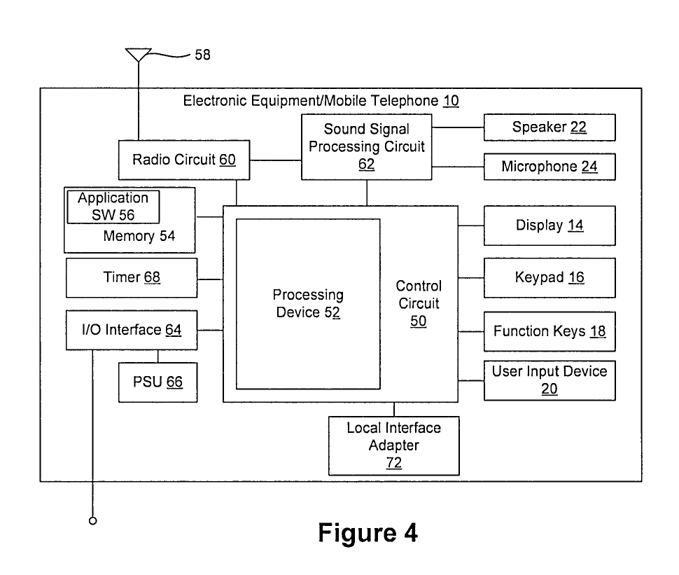

The display 14 displays information to a user such as operating state, time, telephone numbers, contact information, various navigational menus, status of one or more functions, etc., which enable the user to utilize the various features of the mobile telephone 10. The display 14 may also be used to visually display content accessible by the mobile telephone 10. Preferably, the displayed content is displayed in graphical user interface that allows manipulation of objects and/or files by selection of the object and/or file by the user input device 20. The displayed content may include graphical icons, bitmap images, graphical images, three-dimensional rendered images, E-mail messages, audio and/or video presentations stored locally in memory 54 (FIG. 4) of the mobile telephone 10 and/or stored remotely from the mobile telephone 10 (e.g., on a remote storage device, a mail server, remote personal computer, etc.). The audio component may be broadcast to the user with a speaker 22 of the mobile telephone 10. Alternatively, the audio component may be broadcast to the user though a headset speaker (not shown).

The mobile telephone 10 further includes a keypad 16 that provides for a variety of user input operations. For example, the keypad 16 may include alphanumeric keys for allowing entry of alphanumeric information such as user-friendly identification of contacts, filenames, E-mail addresses, distribution lists, telephone numbers, phone lists, contact information, notes, etc. In addition, the keypad 16 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone 10 may include a volume key, audio mute key, an on/off power key, a web browser launch key, an E-mail application launch key, a camera key, etc. Keys or key-like functionality may also be embodied as a touch screen associated with the display 14.

The user input device 20 may any type of user input device. Preferably, the user input device 20 is touchpad. The touchpad may be any type of touchpad (e.g., capacitive, resistive, etc.). The user input device 20 may be located in any desirable position on the mobile telephone 10. For example, the user input device 20 may be located near the display 14, as shown in FIG. 1. Alternatively, the user input device 20 may be located near the microphone 24, as shown in FIG. 1B.

An exemplary user input device 20 in the form of a touchpad is illustrated in FIG. 2. The user input device 20 has an associated X-axis and Y-axis, which correspond to a relative location on display 14. For example, as the user moves an object along the user input device 20, a cursor or other pointing device presented on the display 14 will traverse across the display 14 in a similar or predetermined manner. The user input device 20 also has a Z-axis (into and out of the page), which corresponds to the applied pressure sensed by the user input device 20. Generally increased pressure on the user input device 20 causes the display 14 to zoom in a particular area of interest. Likewise, reduced pressure on the user input device 20 causes the display 14 to zoom out of a particular area of interest. The user input device may also include areas having predefined and/or assigned functions. For example, the user input device may optionally include a scroll control 30 and/or a pan control 32. Other predefined function areas may include an area to simplify inputting numbers, text, formatting, application buttons, etc.

The user input device 20 is capable of providing one or more signals to the processor 52 (shown in FIG. 4), wherein the signals are indicative of a location and an applied pressure of an object touching the user input device 20. The user input device 20 may provide separate signals for the location signal and the applied pressure signal. Alternatively, the location and applied pressure signals may be combined in a composite signal.

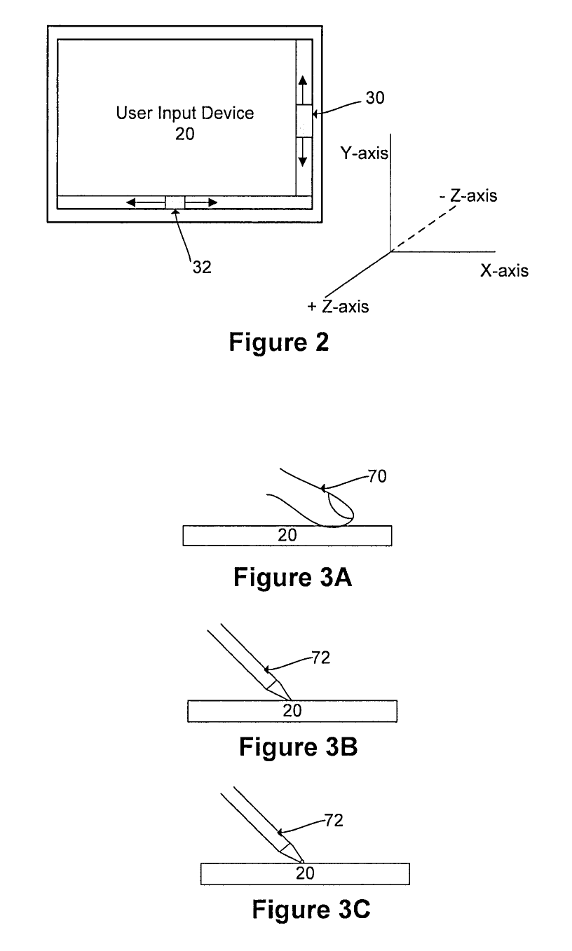

Generally the location signal is measured directly by X-axis and Y-axis position sensors. The position sensors form a matrix that is capable of sensing an object. The object may be any suitable object. Suitable objects include, for example, an associated user's finger 70 (as shown in FIG. 3A), a stylus or pointer (as shown in FIG. 3B), a pen (as shown in FIG. 3C), etc. Typically, the location signal is measured directly from the X-axis and Y-axis position sensors associated with the user input device 20. However, one of ordinary skill will readily appreciate that indirect measurements of X-axis and Y-axis position of the object moves across the user input device 20 may also be provided. For example, by averaging the X and Y coordinate positions of the object making contact with the user input device 20.

The applied pressure signal may be measured directly from a sensor that detects force and/or pressure in the Z-axis of the user input device 20. In addition, applied pressure signal sensed by the user input device 20 may be measured indirectly. For example, a capacitive touchpad measures the area of contact between the object and the touchpad. Once that area is measured, relative applied pressure is determined by the change in the area over time. For example, as a user pushes harder with his or her finger, more area is in contact and the touchpad estimates a greater pressure.

As explained below, the processor 52 process the signals received from the user input device 20 in any desirable manner. The processor 52 may work in conjunction with the application software 56 to provide the functionality described herein. For example, a cursor displayed on the display 14 may be controlled by operation of the user input device 12 through operation of the processor 52 and application software 56. For example, if the user moves an object touching the user input device 20 to the left or to the right, the processor 52 and the application software 56 will utilize the position information generated therefrom and the cursor will move correspondingly to the left or to the right on the display 14. Likewise, if the user asserts more or less applied pressure on the user input device 20, the display will zoom in or zoom out, respectively at the location in which the cursor is located, as described in detail below. In addition, the user input device 20 may select a graphical object displayed on the display 14. Generally the graphical object will be a graphical representation of a person, place or thing. Upon selection of the graphical object, the user may manipulate the graphical object by touching the user input device 12 with an object and the processor 52 in conjunction with the application software 56, will process the position signals and asserted pressure signals in a predetermined or in a manner specified by the user. For example, when the user slides the object on the user input device 12 from left to right, the graphical object displayed on the display 14 will rotate from left to right. Likewise, when the user exerts additional applied pressure on the user input device 12, the display 14 will appear to zoom in on the object. Other exemplary functions include, for example, zooming out from the object when a decrease in applied pressure is detected, rotating the graphical object from right to left when the user slides the object on the user input device 12 from right to left, etc.

In addition, upon selecting a graphical object displayed on display 14, a graphical feedback and/or an audible feedback may also be provided to the user. For example, after the user selects a file cabinet icon displayed on the display 14 and the user exerts additional applied pressure on the user input device 20 to open the file cabinet, the file cabinet opening may be displayed with a visual representation of the file cabinet opening. Alternatively, an audible signal representing the file cabinet opening may be output from the speaker 22. Preferably, a visual representation and an audible signal are utilized to provide a user with feedback that an action took place.

Additionally, the user input device 20 may also be used to place files and/or other information in locations in the third dimension (along the Z-axis) for increased organization. For example, after selecting an object, the user may impart increased and/or reduced asserted pressure on the user input device 20 in order to move the object to a different plane on the display.

Referring to FIG. 4, a functional block diagram of the mobile telephone 10 is illustrated. The mobile telephone 10 includes a primary control circuit 30 that is configured to carry out overall control of the functions and operations of the mobile telephone 10. The control circuit 50 may include a processing device 52, such as a CPU, microcontroller or microprocessor. The processing device 52 executes code stored in a memory (not shown) within the control circuit 50 and/or in a separate memory, such as memory 54, in order to carry out operation of the mobile telephone 10. The processing device 52 is generally operative to perform all of the functionality disclosed herein.

The memory 54 may be, for example, a buffer, a flash memory, a hard drive, a removable media, a volatile memory and/or a non-volatile memory. In addition, the processing device 32 executes code to carry out various functions of the mobile telephone 10. The memory may include one or more application programs and/or modules 56 to carry out any desirable software and/or hardware operation associated with the mobile telephone 10.

Continuing to refer to FIGS. 1 and 4, the mobile telephone 10 also includes conventional call circuitry that enables the mobile telephone 10 to establish a call, transmit and/or receive E-mail messages, and/or exchange signals with a called/calling device, typically another mobile telephone or landline telephone. However, the called/calling device need not be another telephone, but may be some other electronic device such as an Internet web server, E-mail server, content providing server, etc. As such, the mobile telephone 10 includes an antenna 58 coupled to a radio circuit 60. The radio circuit 60 includes a radio frequency transmitter and receiver for transmitting and receiving signals via the antenna 58 as is conventional. The mobile telephone 10 generally utilizes the radio circuit 60 and antenna 58 for voice, Internet and/or E-mail communications over a cellular telephone network. The mobile telephone 10 further includes a sound signal processing circuit 62 for processing the audio signal transmitted by/received from the radio circuit 60. Coupled to the sound processing circuit 62 are the speaker 22 and microphone 24 that enable a user to listen and speak via the mobile telephone 10 as is conventional. The radio circuit 60 and sound processing circuit 62 are each coupled to the control circuit 50 so as to carry out overall operation of the mobile telephone 10.

The mobile telephone 10 also includes the aforementioned display 14, keypad 16 and user input device 20 coupled to the control circuit 50. The mobile telephone 10 further includes an I/O interface 64. The I/O interface 64 may be in the form of typical mobile telephone I/O interfaces, such as a multi-element connector at the base of the mobile telephone 10. As is typical, the I/O interface 64 may be used to couple the mobile telephone 10 to a battery charger to charge a power supply unit (PSU) 66 within the mobile telephone 10. In addition, or in the alternative, the I/O interface 64 may serve to connect the mobile telephone 10 to a wired personal hands-free adaptor, to a personal computer or other device via a data cable, etc. The mobile telephone 10 may also include a timer 68 for carrying out timing functions. Such functions may include timing the durations of calls, generating the content of time and date stamps, etc.

The mobile telephone 10 may include various built-in accessories, such as a camera 70 for taking digital pictures. Image files corresponding to the pictures may be stored in the memory 54. In one embodiment, the mobile telephone 10 also may include a position data receiver (not shown), such as a global positioning satellite (GPS) receiver, Galileo satellite system receiver or the like.

In order to establish wireless communication with other locally positioned devices, such as a wireless headset, another mobile telephone, a computer, etc., the mobile telephone 10 may include a local wireless interface adapter 72. The wireless interface adapter 72 may be any adapter operable to facilitate communication between the mobile telephone 10 and an electronic device. For example, the wireless interface adapter 50 may support communications utilizing Bluetooth, 802.11, WLAN, Wifi, WiMax, etc.

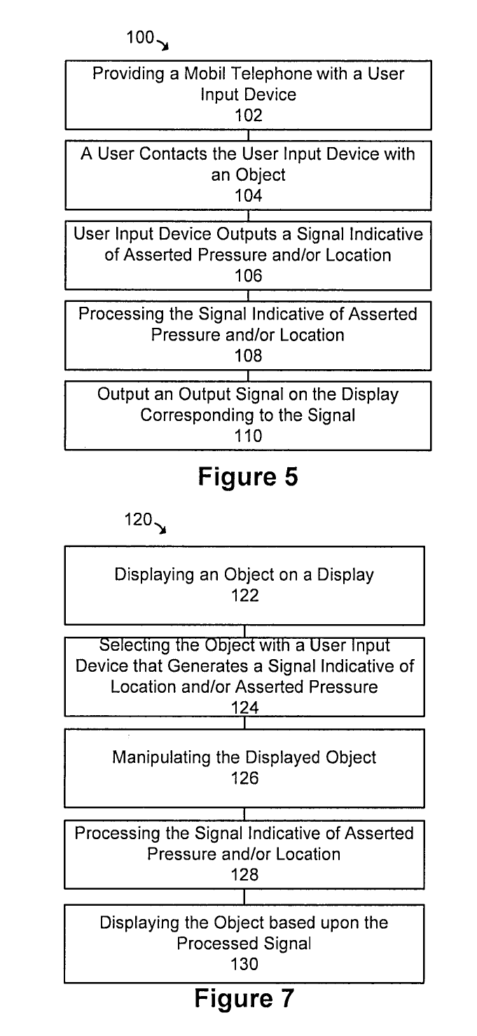

Operation of the user input device 20 will now be discussed. Referring to FIG. 5, an exemplary method 100 in accordance with one aspect of the present invention is illustrated. The method 100 provides position information (the phrase “location information” may used interchangeably with “position information”) and applied pressure information to a processor (e.g., processor 52). At step 102, a mobile telephone 10 having a user input device 20 is provided. The user input device is capable of generating and/or otherwise providing a signal, wherein the signal is indicative of a location and an applied (also referred to herein as “asserted”) pressure of an object touching the touchpad. At step 104, an associated user contacts the user input device 20 with an object. The object may be any object that causes the user input device 20 to produce or otherwise generate a signal indicative of location and asserted pressure of the object on the user input device 20. As described above, exemplary objects include an associated user's finger, a stylus or pointing device, a pen, etc.

At step 106, the user input device 20 outputs a signal indicative of the asserted pressure and/or location of the object on the user input device 20. At step 108, the signal indicative of location and asserted pressure is processed in order to determine the location and/or the applied pressure of the object on the user input device 20. The processor 52 generally processes the signals received from the user input device 20 in any desirable manner. The processor 52 may work in conjunction with the application software 56 to provide the functionality described herein. For example, a cursor displayed on the display 14 may be controlled by operation of the user input device 20 through operation of the processor 52 and application software 56.

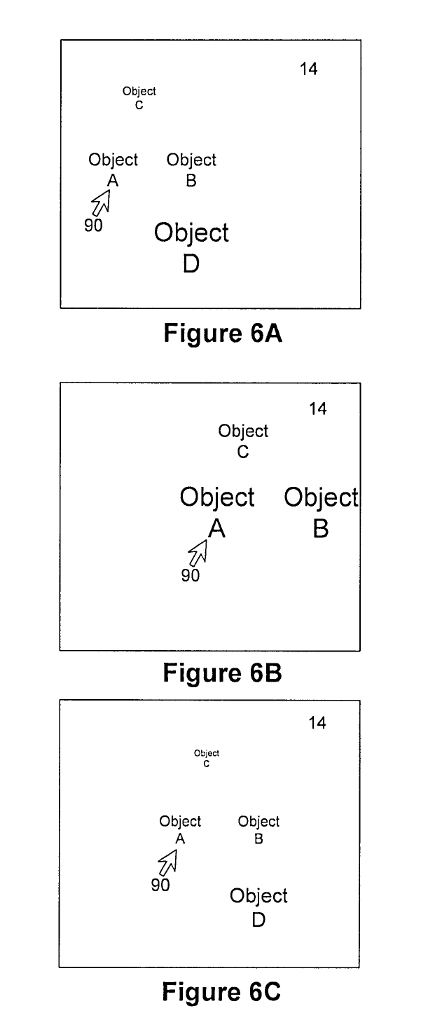

At step 110, an output signal is output on the display corresponding to the signal produced by user identification device 20. For example, as the user moves an object along the user input device 20, a cursor or other pointing device presented on the display 14 will traverse across the display 14 in a similar or predetermined manner. In addition, when the user input device 20 senses an increase and/or decrease in asserted pressure, the display 14 zooms in or out of a particular area of interest. An exemplary application is illustrated in FIG. 6. Referring to FIG. 6A, a display 14 has four objects displayed thereon (Object A, Object B, Object C and Object D) and a cursor 90 displayed thereon. As the user increases the asserted pressure on the user input device 20, the display area near the cursor generally increases correspondingly (i.e., zooms in on the area near the cursor), as shown in 6B, which gives the appearance of the display presenting the objects in three dimensions. As shown in FIG. 6B, the display 14 zooms in and Object B is no longer visible since Object D is positioned on a level above the other displayed objects. Likewise, when the user input device 20 senses a decrease in asserted pressure, the display zooms out, as shown in FIG. 6C. As shown in FIG. 6C, all objects (e.g., Objects A-D) are visible at various display levels on display 14, which provides a three dimensional representation of the objects to the associated viewer.

Referring to FIG. 7, an exemplary method 120 is illustrated in accordance with aspects of the present invention. The exemplary method 120 is utilized for manipulating an object on display 14. At step 122, at least one object is displayed on a display. The object may be anything capable of being represented on a display 14. At step 124, the associated user selects at least one object with a user input device 20 (e.g., a touchpad), wherein the touchpad provides a signal indicative of a location and an applied pressure of an object touching the touchpad, as discussed above. At step 126, the displayed object moves on the display in a predetermined manner based on the signal received from the touchpad.

A user, using the user input device 20 may select the graphical object displayed on the display 14. Generally the graphical object will be a graphical representation of a person, place or thing. Upon selection of the graphical object, the user may manipulate the graphical object by touching the user input device 12 with an object and the processor 52 in conjunction with the application software 56, will process the position signals and asserted pressure signals in a predetermined or in a manner specified by the user. For example, when the user slides the object on the user input device 12 from left to right, the graphical object displayed on the display 14 will rotate from left to right. Likewise, when the user exerts additional applied pressure on the user input device 12, the display 14 will appear to zoom in on the object. Other exemplary functions include, for example, zooming out from the object when a decrease in applied pressure is detected, rotating the graphical object from right to left when the user slides the object on the user input device 12 from right to left, etc.

One exemplary use case for the present invention is real estate sales. A three dimensional representation of a house may be presented to the user. The user, utilizing the user input device 20, may investigate the house by entering the front door and investigating the rooms by increasing and/or decreasing the asserted pressure on the user input device 20, which causes the display to zoom in and/or out, respectively.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A mobile telephone comprising:
a processor;
a user input device for providing a signal to the processor, wherein the signal is indicative of a location and an applied pressure of an object touching the user input device;
a display coupled to the processor, wherein the display outputs an output signal corresponding to the signal; and wherein, the processor causes the display to zoom in and/or zoom out based upon a change in the applied pressure.

2. The mobile telephone of claim 1, wherein the user input device is a touchpad.

3. The mobile telephone of claim 2, wherein the touchpad is integrated in the mobile telephone.

4. The mobile telephone of claim 1, wherein the user input device is a touch screen.

5. The mobile telephone of claim 1, wherein signal includes a first component related to the location and a second component related to the applied pressure.

6. The mobile telephone of claim 1, wherein the output signal is in the form of a cursor.

7. The mobile telephone of claim 1, wherein the display is a liquid crystal display.

8. The mobile telephone of claim 1, when the processor calculates increasing applied pressure, the display zooms in an area associated with the location.

9. The mobile telephone of claim 1, when the processor calculates decreasing applied pressure, the display zooms out of an area associated with the location.

10. A mobile telephone comprising:
a processor;
a touchpad for providing a signal to the processor, wherein the signal is indicative of a location and an applied pressure of an object touching the touchpad;
a display coupled to the processor, wherein the display outputs an output signal corresponding to the signal; and wherein, the processor causes the display to zoom in and/or zoom out based upon a change in the applied pressure.

11. The mobile telephone of claim 10, wherein the touchpad is integrated in the mobile telephone.

12. The mobile telephone of claim 10, wherein signal includes a first component related to the location and a second component related to the applied pressure.

13. The mobile telephone of claim 10, wherein the display is a liquid crystal display.

14. The mobile telephone of claim 10, when the processor calculates increasing applied pressure, the display zooms in an area associated with the location.

15. The mobile telephone of claim 10, when the processor calculates decreasing applied pressure, the display zooms out of an area associated with the location.

16. A method for providing location information and applied pressure information to a processor, the method comprising:
providing a touchpad for providing a signal, wherein the signal is indicative of a location and an applied pressure of an object touching the touchpad;
receiving a signal from the object touching the touchpad;
outputting a signal indicative of the location and the applied pressure;
processing the signal in order to determine the location and the applied pressure; and
outputting an output signal on a display corresponding to the signal.

17. The method of claim 16 further comprising determining whether the applied pressure is increasing and/or decreasing.

18. The method of claim 17 further comprising zooming in on the location if applied pressure is increasing.

19. The method of claim 18 further comprising zooming out on the location if applied pressure is decreasing.

20. The method of claim 17 further comprising providing a tactile feedback based upon the determination of whether the applied pressure is increasing and/or decreasing.

21. A computer program stored on a machine readable medium in a mobile telephone, the program being suitable for receiving location information and applied pressure information from a touchpad, wherein when the touchpad determines an increase and/or a decrease in applied pressure, a display associated with the mobile telephone zooms in and/or zooms out based upon the amount of applied pressure detected.

22. A method for manipulating an object on a display, the method comprising: displaying an object on a display;
selecting the object with a touchpad, wherein the touchpad provides a signal indicative of a location and an applied pressure of an object touching the touchpad; and
manipulating the displayed with the user input device;
outputting a signal indicative of the location and the applied pressure from the step of manipulation;
processing the signal in order to determine the location and the applied pressure; and
outputting an output signal on a display corresponding to the signal.
